(19) United States
(12) Patent Application Publication
(10) Pub. No.: US 2003/0068426 A1
(43) Pub. Date: Apr. 10, 2003

(54) Process to prevent and delay clouding in palm olein

(75) Inventors: Nor Aini Idris, Kajang (MY); Radzuan Jamaludin, Bandar Baru Bangi (MY); Hanirah Hassan, Bandar Baru Bangi (MY)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: MALAYSIAN PALM OIL BOARD

(21) Appl. No.: 10/261,932

(22) Filed: Oct. 2, 2002

(30) Foreign Application Priority Data
Oct. 5, 2001 (MY) PI 2001 4654

(51) Int. Cl. A23D 7/00

(52) U.S. Cl. 426/601

(57) ABSTRACT

The invention discloses a process to delay clouding in palm olein by the addition of a crystallization inhibitor to the palm olein. The palm olein is first heated to a temperature of between 60 to 140° C. A small proportion of crystallization inhibitor with a hydrophilic-lipophilic balance value between 1 and 16 is added to a sample of palm olein and the mixture is stirred until homogenous. The stirred mixture is then added to the pre-heated palm olein and the resultant mixture is stirred until homogenous and is cooled before packing into individual containers.

### FIELD OF INVENTION

This invention relates to a method of preventing and/or delaying clouding in palm olein and in blends of palm olein with other oils. The invention also relates to a composition of palm olein or blend of palm olein with other oils wherein there is no clouding or the onset of clouding is delayed.

### BACKGROUND OF THE INVENTION

Cloud formation in palm olein during transportation and storage in cold climates is a problem. The cloud formation is due to crystallization of palm olein when the palm olein is subjected to low temperatures. Single fractionated palm olein may cloud during display on supermarket shelves. Although there is nothing wrong with the oil quality, it is important to prevent crystallization because consumers-perceive a cloudy oil as deteriorated oil. The crystals formed in palm olein at low temperatures are high in diglycerides. On the other hand, diglycerides have been found to retard crystallization in oil and fats. The problem of clouding in palm olein has been partially overcome to a certain extent by blending with soft oils or adding additives or using a double fractionation method. Sorbitan tristearate was reported to inhibit crystal formation in oleins with low cloud points. The optimum dosage of sorbitan tristearate in palm olein depends on the test temperature, the higher the temperature, the higher the optimum dosage. A typical dosage is 0.05-0.15%. Adding ant-crystallizer (sorbitan tristearate) was reported to be more effective in resisting clouding in the palm olein rather than blending palm olein with 35% soya oil. U.S. Pat. No. 2,097,720 discloses that a small proportion (less than 1%) of a polymerized oxidized iono-unsaturated disaturated glyceride was used to treat olive oil in order to prevent clouding or formation of stearin at low temperatures. U.S. Pat. No. 2,393,744 discloses that soy lecithin can be used to depress the formation of crystals in cottonseed oil, thus prolonging cold test of the oil.

It is an objective of this invention to obtain a more effective method of preventing or delaying clouding in palm olein per se or in blends of palm olein.

### SUMMARY OF THE INVENTION

The invention discloses a process to delay clouding in palm olein by the addition of a crystallization inhibitor to the palm olein. The palm olein is first heated to a temperature between 60 to 140° C. A small proportion of crystallization inhibitor with a hydrophilic-lipophilic balance value between 1 and 16 is added to a sample of preheated palm olein and the mixture is stirred until homogenous. The stirred mixture is then added to the pre-heated palm olein and the resultant mixture is stirred until homogenous and is cooled before packing into individual containers.

In another aspect the invention relates to a process where crystallization inhibitors with a hydropholic-lipophilic value of 1 is added to palm olein and the resultant mixture is heated to 130° C. The mixture is stirred until all the inhibitors are dissolved and thereafter the mixture is cooled before packing into individual containers.

Yet in another aspect the invention relates to a process of delaying clouding in a blend of palm olein and one or more vegetable oils selected from a group consisting of soy bean oil, sunflower oil, rapeseed oil or canola oil, corn oil, olive oil, safflower oil, cottonseed oil, rice bran oil, sesame oil, mustard seed oil and peanut oil. A small proportion of crystallization inhibitors is added to the blend. The mixture is heated to a temperature between 60 to 140° C. until all the crystallization inhibitors are completely dissolved.

The palm olein has an iodine value between 55 and 70 and is obtained from either single or double fractionation of palm oil or from a mixture of both.

The crystallization inhibitors include sucrose esters of fatty acids, polyglycerol esters of fatty acids and wherein the fatty acids are of any chain lengths from C4 to C24. The crystallization inhibitor also include sorbitan tristearate which is added to palm olein blended with other edible oils.

### DETAILED DESCRIPTION OF THE INVENTION

This invention relates to a process to prevent or delay clouding in palm olein and blends of palm olein with other oils during handling, distribution and storage. By preventing clouding, clarity of the oil can be maintained. The term “clouding” refers to cloud formation as a result of crystallization of palm olein when subjected to low or air-conditioned temperatures. The term palm olein refers to the liquid fraction obtained in the fractionation process of palm oil. The term palm olein as used herein refers to that having an IV of 55 to 70.

The invention relates to a process of blending palm olein with a certain type of additive or emulsifier. The additive/emulsifier includes a compound of sucrose and fatty acids derived from edible oils and fats. The fatty acids comprise one or more C4 to C24 fatty acids and they may be saturated or unsaturated and may have straight or branched chains. The additives/emulsifier which act as crystal inhibitors in this invention can be in the form of liquid, waxy substances, powder, paste or pellets. The colour can range from white to yellow, brownish-yellow or slightly greyish white. The acid value should not be more than 6, free sugar not more than 5% and water content not more than 4%.

Another type of additive is polyglycerol esters of fatty acids. Polyglycerol esters of fatty acids are mixed partial esters formed by reacting polymerized glycerols with edible fats, oils or fatty acids. The fatty acids may comprise one or more C4 to C24 fatty acids and they may be saturated or unsaturated and may have straight or branched chains. Minor amounts of mono-, di-, and triglycerides, free glycerol and polyglycerols, free fatty acids and sodium salts of fatty acids may be present. The polyglycerols vary in degree of polymerization. By varying the proportions as well as the nature of the fats or fatty acids to be reacted with the polyglycerols, a large and diverse class of products may be obtained. The product characteristics can be varied for instance the colour may range from light yellow to amber and from light tan to brown. The products' consistency can range from oily to very viscous liquid, plastic or soft solids to hard, waxy solids. The esters range from very hydrophilic to very lipophilic.

The selected emulsifiers should have hydrophobic-lipophilic balance (HLB) values between 1 to 16. They have been found to have a favourable influence on crystallization behavior of oils and fats. The use of emulsifiers as food additives is governed by legislation in most countries in the world. These emulsifiers are very safe and harmless. They have been used in human foods for many years. The said emulsifiers are used in this invention as crystal inhibitors, also known as anti-crystallizers. Crystal inhibitors or anti-crystallizers are materials which when added to an oil, retard crystal formation. The amount of crystal inhibitor used is between 0.005% to 2.0% by weight of the palm olein. The efficiency of the crystal inhibitor to prevent clouding in palm olein varies with the temperature of storage and levels of crystal inhibitor used.

The crystal inhibitor or mixture of crystal inhibitors and palm olein can be mixed together in any convenient manner. For instance, if the crystal inhibitor is in a liquid form, it can be mixed directly with palm olein. However, it is better to stir and heat the mixture to ensure that it is homogeneous. If the crystal inhibitor is in a solid form, it can be dissolved in the palm olein. It is desirable to heat the palm olein or the mixture to facilitate homogeneous solution.

The process may also involve mixing the crystal inhibitors thoroughly with a portion of palm olein which is preheated to a temperature above 60° C. The mixture is stirred and the remaining palm olein is added to the mixture and heating is continued to ensure formation of a homogeneous mixture.

### EXAMPLE 1

A measured quantity of palm olein was filtered using Whatman qualitative filter paper (Whatman International Ltd. England) and filter funnels in a warming cabinet at 60° C. Then, beakers labeled with the name of the crystal inhibitor and the percentage used were prepared. Filtered palm olein was poured into each beaker and heated to 130° C. Crystal inhibitor with HLB value between 1 to 5 was put into each beaker and mixed in thoroughly. The remaining palm olein was added to the mixture in the beakers and heating was continued at 130° C. to ensure that all triglycerides were melted. The mixture was poured into plastic bottles. The samples were allowed to cool at room temperature before they were stored at different temperatures. Observations were conducted daily to determine how long the samples remained clear. Cloud point was carried out according to AOCS method No. Cc11-53. Cloud points of the samples ranged between 2 to 7° C.

Palm olein mixed with 0.5% crystal inhibitor stored at 20° C. remained clear for more than 220 days. The control sample (without crystal inhibitor) remained clear at 20° C. for 14 days only. At storage temperature of 15° C., the mixture remained clear for more than 130 days while the control sample remained clear for only 4 days at 15° C.

### EXAMPLE 2

Another crystal inhibitor with an HLB value of 1 was added to palm olein at 0.05% and 0.1% by weight. The mixture was heated to a temperature above 60° C. with continuous stirring. The heated mixture was poured into bottles and allowed to cool at room temperature. They were then stored in incubators at different temperatures, together with bottles containing palm olein without any additive as a control. The samples were inspected at regular intervals. The following results were obtained.

TABLE 1
Resistance to crystallization of palm olein (IV 65) containing additives at
0.05% and 0.1% ww

| | Chill Test (days remained clear) | | |
|---|---|---|---|
| | Palm olein (IV 65) | | |
| Storage Temperature | with crystal inhibitor | | |
| (° C.) | (0.05%) | (0.1%) | Control |
| 20 | 130 | >220 | 14 |
| 15 | 22 | 75 | 4 |
| 10 | 5 | 8 | <1 |

### EXAMPLE 3

Another crystal inhibitor with an HLB value of 2 to 16 was added to palm olein at 0 5, 0.1 and 0.05% by weight The mixture was heated to 70° C. with continuous stirring. The heated materials were poured into bottles and allowed to cool at room temperature. They were then stored at different temperatures, together with bottles containing palm olein without any additive. The samples were inspected at regular intervals. The following results were obtained

TABLE 2
Resistance to crystallization of palm olein (IV65) containing a
polyglycerol ester at 0.5%. 0.1% and 0.05% ww

| | Chilled Test (days remained clear) | | | |
|---|---|---|---|---|
| Storage temperature | Palm olein with crystal inhibitor | | | |
| (° C.) | 0.5% | 0.1% | 0.05% | Control |
| 20 | >220 | 190 | 120 | 14 |
| 15 | 170 | 30 | 15 | 4 |
| 10 | 3 | 5 | 3 | <1 |

### EXAMPLE 4

Blends of single fractionated palm olein with another oil (soybean oil) were prepared. A mixture of additives (sucrose polyester and polyglycerol ester T-15) was added to the blended oil at 0.1% ww. The sample was heated (temperature above 60° C.) until all the triglycerides and additives were melted. The heated mixture was poured into bottles and allowed to cool at room temperature. They were then stored in incubators at different temperatures, together with bottles containing blends of palm olein with soybean oil without any additive as a control. The samples were inspected at regular intervals. The following results were obtained.

TABLE 3
Resistance to crystallization of single fractionated palm olein IV 56:
soybean oil blend (SBO) containing a mixture of additives (sucrose
polyester and polyglycerol ester T-15) at 0.1% ww compared to control

| | Chill Test (days sample remained clear) | | | |
|---|---|---|---|---|
| | POo:SBO + Additives | | Control | |
| Temperature (° C.) | 20:80 | 40 60 | 20 80 | 40.60 |
| 20° C. | >240 | >240 | 65 | 47 |
| 15° C. | >120 | <90 | 55 | <2 |
| 10° C. | >65 | <2 | <2 | <1 |

### EXAMPLE 5

Palm olein IV 56 was heated to 80° C. A 1:1 ratio of polyglycerol esters T-15 and M-18 were added to the pre-heated palm olein IV 56 at various levels (0, 0.01, 0.05, 0.1 and 0.5%) ww. The mixture was reheated with continous stirring to ensure it was homogenized. The heated mixture was poured into bottles and allowed to cool at room temperature. They were then stored at various temperatures and observations were conducted at regular intervals. The following results were obtained.

TABLE 4
Resistance to crystallization of palm olein IV 56 containing equal ratio of
polyglycerol esters T-15 and M-18

Temperature (° C.)

| Level of T-15:M-18 (%) | 10 | 15 | 20 | |
|---|---|---|---|---|
| 0 (Control) | <4 h | <20 h | <24 | h |
| 0.01 | <3 h | <20 h | <44 | h |
| 0.05 | <20 h | <28 h | <6 | days |
| 0.1 | <20 h | <44 h | <6 | days |
| 0.5 | <20 h | <28 h | >30 | days |

h = hour sample remained clear

### EXAMPLE 6

Palm olein IV 60 was heated to 80° C. A crystal inhibitor, polyglycerol ester M-18 was added to the preheated sample at 0.05%. Heating was continued with stirring to get a homogenized mixture. The sample was poured into bottles and allowed to cool at room temperature. Samples were inspected at regular intervals. The following results were obtained.

TABLE 5
Resistance to crystallization of palm olein IV 60 containing 0.05% ww
polyglycerol ester M-18

| | Chilled test (hours or days sample remained clear) | | | |
|---|---|---|---|---|
| Temperature (° C.) | POo IV 60 + 0.05% M-18 | | Control | |
| 10 | 21 | h | <21 | h |
| 20 | >160 | days | <12 | days |

### EXAMPLE 7

Another additive, sorbitan tristearate was added at 0.1% to a 40:60 blend of palm olein IV 56 with sunflower oil. The sample was heated to a temperature between 60 and 140° C. with continous stirring to ensure a homogenous mixture. The sample remained clear at 20° C. for more than 300 days compared to the control blend (without any additive) which remained clear for only 55 days.

### EXAMPLE 8

A 40:60 blend of palm olein IV 56 with corn oil containing 0.1% sorbitan tristearate remained clear for more than 230 days at 20° C. and more than 60 days 15° C. The control sample (without any additive) remained clear for only 34 days at 20° C. and 16 days at 15° C.

The trials were repeated for blends of palm olein with other vegetable oils such as rapeseed/canola oil, safflower oil, cottonseed oil, olive oil, nice bran oil, mustard seed oil and peanut oil. Acceptable results corresponding to results in Example 7 and 8 were obtained

1. A process to delay clouding in palm olein by the addition of a crystallization inhibitor to the palm olein characterized in that the process includes the steps:
i) elevating the temperature of palm olein to between 60 to 140° C.;
ii) adding a quantity of one or more crystallization inhibitors with a hydrophobic-lipophilic balance value between 1 and 16 to a sample of the palm olein from step (i);
iii) adding the mixture of step (ii) to the palm olein from step (i) and maintaining the temperature above 60° C. until mixture is homogenized;
iv) cooling the mixture of step (iii) to room temperature or to temperature of supermarket display shelf.

2. A process to delay clouding in palm olein by the addition of a crystallization inhibitor to the palm olein characterized in that the process includes the steps
i) addition of one or more crystallization inhibitors with a hydrophobic-lipophobic value of 1 to palm olein and heating the mixture to above 60° C.;
ii) keeping the mixture stirred until all the crystallization inhibitors have been dissolved in the mixture;
iii) cooling the mixture of step (ii) to room temperature or temperature of supermarket display shelf.

3. A process to delay clouding in palm olein by the addition of a crystallization inhibitor to the palm olein characterized in that the process includes the steps:
i) blending the palm olein with a oil selected from the group comprising of soybean oil, sunflower oil, rapeseed oil or canola oil, corn oil, olive oil, safflower oil, cottonseed oil, rice bran oil, sesame oil, mustard seed oil and peanut oil,
ii) addition of a mixture of crystallization inhibitors;
iii) heating the mixture from step (ii) until all the crystallization inhibitors are completely dissolved.

4. A process to delay clouding in palm olein as claimed in any claims 1 to 3 wherein the palm olein has an iodine value between 55 and 70.

5. A process to delay clouding in palm olein as claimed in any claims 1 to 3 wherein the palm olein are obtained from either single or double fractionation of palm oil or a mixture of both.

6. A process to delay clouding in palm olein as claimed in claims 1 and 2 wherein the palm olein is mixed with other edible oils.

7. A process to delay clouding in palm olein as claimed in claims 4 and 6 wherein 50% or less of palm olein is blended with 50% or more of other edible oils.

8. A process to delay clouding in palm olein as claimed in claims 4 and 6 wherein the best ratio of blends are those containing more than 70% of the other oil and 30% or less of palm olein, 30% or less of palm olein is blended with 70% or more of other edible oils.

9. A process to delay clouding in palm olein as claimed in any claims 1 to 3 wherein the crystallization inhibitor includes emulsifiers with a hydrophobic-lipophilic balance value between 1 to 16.

10. A process to delay clouding in palm olein as claimed in any claims 1 to 3 wherein the crystallization inhibitor includes sucrose esters of fatty acids and wherein the fatty acids are of any chain length from C4 to C24.

11. A process to delay clouding in palm olein as claimed in any claims 1 to 3 wherein the crystallization inhibitor includes polyglycerol esters of fatty acids wherein the fatty acids are of any chain length from C4 to C24.

12. A process to delay clouding in palm olein blended with other edible oils as claimed in claims 6 wherein sorbitan tristearate is added between 0.005% to 2.0% ww.

13. A process to delay clouding in palm olein as claimed in any claim 1 to 3 wherein quantity of crystallization inhibitors is between 0.005% to 2.0% ww.

14. Palm olein or a blend of palm olein and other edible oils produced according to any of the process as claimed in claims 1 to 13.

15. Palm olein or a blend of palm olein and other edible oils containing 0.005% to 2.0% ww of crystallization inhibitors with a hydrophobic-lipophilic balance value between 1 and 16.

16. Palm olein blended with one or more vegetable oils selected from the group consisting of soybean oil, sunflower oil, rapeseed oil or canola oil, corn oil, olive oil, safflower oil, cottonseed oil, rice bran oil, sesame oil, mustard seed oil, peanut oil and containing below 2.0% ww of one or more crystallization inhibitors.

17. Palm olein blended with one or more vegetable oils as claimed in claim 16 wherein the ratio of palm olein to other vegetable oil or oils is between 5:95 to 50:50 respectively.
